(19) United States
(12) Patent Application Publication
(10) Pub. No.: US 2016/0332159 A1
(43) Pub. Date: Nov. 17, 2016

(54) ACOUSTOPHORETIC DROPLET HANDLING IN BULK ACOUSTIC WAVE DEVICES

(71) Applicant: ETH ZURICH, Zurich (CH)

(72) Inventors: Jurg DUAL, Elsau (CH); Ivo LEIBACHER, Zurich (CH); Peter REICHERT, Zurich (CH)

(73) Assignee: ETH ZURICH, Zurich (CH)

(21) Appl. No.: 15/111,854

(22) PCT Filed: Jan. 12, 2015
(86) PCT No.: PCT/EP2015/050388

§ 371 Date: Jul. 15, 2016

(30) Foreign Application Priority Data
Jan. 15, 2014 (EP) 14000149.6

(51) Int. Cl. B01L 3/00; B01F 11/02; B01F 13/00

(52) U.S. Cl. CPC B01L 3/50273; B01L 3/502715; B01F 13/0071; B01F 11/0241; B01L 2300/0858; B01L 2400/0436; B01L 2300/041; B01L 2300/0816; B01L 2200/0673; B01F 2215/0037

(57) ABSTRACT

An acoustofluidic system comprises a substrate (10) having an essentially rectangular recess with side walls (33), wherein the recess provides a microfluidic channel (30) containing a fluid with droplets (31), and at least one electromechanical transducer (20) attached at the substrate (10) adapted to excite an acoustic field in said channel (30). The side walls (33) are hard acoustic walls having a high specific acoustic impedance mismatch to said fluid in the channel (30) and the transducer (20) is configured to excite bulk acoustic waves (BAW) as standing waves (32) of a predetermined harmonic resonance mode between said hard acoustic side walls (33), which couple into the fluid in the channel (30) exerting acoustic pressure on droplets (31) suspended in said fluid towards the pressure nodal line, pressure antinode line or centerline of the standing wave (32).

### TECHNICAL FIELD

The present invention relates to an acoustofluidic system for acoustophoretic droplet handling in bulk acoustic wave devices.

### PRIOR ART

In recent years, droplet-based microfluidics has evolved as a promising approach for the processing of fluid samples. It comprises droplets in the micrometer range of a first fluid (the dispersed phase liquid or gas), which are suspended in a carrier liquid (the continuous phase liquid). Droplet-based microfluidics—or here, more precisely, segmented flow microfluidics—has its main applications for
biological assays (where droplets are samples for drug discovery, diagnostics, genomics and proteomics),
chemical processing (where droplets are reaction vessels rather than macroscopic beakers and tubes),
synthesis of materials (based on spherical material structures), as well as
experiments with cells, cell clusters or viruses in droplets (where the droplets act as a container for biological experiments).

The format of discrete, isolated fluid droplets/samples has many advantages, like high throughput, low sample consumption, fast processing times and cheap devices based on the lab-on-a-chip concept as mentioned in the publications from Casadevall i Solvas, X. and deMello, A., in “Droplet microfluidics: recent developments and future applications”, Chemical Communications, 47, 7, 1936-1942, 2011, as well as from Dressler, Oliver J., Richard M. Maceiczyk, and Soo-Ik Chang, in “Droplet-Based Microfluidics Enabling Impact on Drug Discovery”, Journal of biomolecular screening 19, 4, 483-496, 2014.

Similar to a macroscopic biochemical laboratory where mixing, pipetting and storing of fluid samples is routinely done, droplets also ask for unit operations such as droplet merging, droplet sorting, droplet focusing, droplet storage and exchange of their continuous phase.

Regarding acoustic droplet handling, most work so far has been done with surface acoustic waves (SAW). In segmented flow microfluidics, an acoustic field in PDMS microchannels is generated on a piezoelectric ground plate with interdigitated transducers (IDT), which acts on droplets by acoustic radiation force or acoustic streaming. Such a disclosure can be found in US 2013/213488 using a surface acoustic wave generator such as an interdigitated transducer, and/or a material such as a piezoelectric substrate.

Bulk acoustic wave (BAW) acoustophoresis has formerly been studied for the handling of cells and particles.

In WO 2007/006322 a method and device for non-intrusively manipulating suspended particles and/or cells and/or viruses is disclosed, which are supplied to a micro-chamber or to a micro-channel of a substrate, said micro-chamber or micro-channel having at least a bottom wall as well as lateral walls. Energy is coupled into the channels and an improved control of standing and/or stationary acoustic wave fields along the channels is provided.

### SUMMARY OF THE INVENTION

Compared to known concepts using SAW, the present method differs as it builds on a bulk acoustic wave (BAW) approach. A standing acoustic wave in the channel is generated by a bulk piezoelectric transducer rather than IDTs. The piezoelectric transducer excites bulk waves and resonance in channels within an acoustically hard material, mostly silicon.

According to the present invention, the handling of droplets is achieved by an acoustic field within bulk acoustic wave devices.

In acoustophoretic systems, a harmonic acoustic field (typically in the MHz range) is set up by a transducer in a microfluidic channel containing the droplets suspended in the continuous phase. The microfluidic channel can be a closed or open channel or be in any shape connected by an inlet and an outlet to the rest of the fluidic system. The fluids can be in motion or be at rest. The transducer is often made of piezoelectric materials. The acoustic field in the fluidic domain can be induced by a bulk acoustic wave or a coupled structure-fluid resonance.

The droplets can be a liquid of chemical or biological interest or it can be a liquid containing cells or other particles. They are subject to forces exerted by the acoustic field (often described by Gorkov's potential) and can therefore be moved in the channels. For example they can be arranged in lines or dots. Such movements of the droplets by the acoustic field enable to perform the mentioned unit operations.

For these handlings, the invention at hand proposes acoustophoresis on bulk acoustic wave (BAW) devices. Whereas BAW acoustophoresis has formerly focused on particle handling, here it is applied for the field of droplet microfluidics. Water-in-oil droplets of 200 μm size or smaller are generated in silicon microdevices for experiments on droplet fusion, focusing, sorting and medium exchange around 0.5-1 MHz acoustic frequency. Compared to existing droplet handling methods, the shown method is simple in fabrication, robust in operation, and versatile to meet the needs of droplet microfluidic devices.

The acoustic handling method termed “acoustophoresis” applies a contact-free, controllable external force field which acts selectively and on demand on dispersed fluid droplets. Unlike other methods, acoustofluidics works on a broad range of droplets with few physical requirements, as long as droplets differ from the continuous liquid in terms of density and/or speed of sound. Furthermore, the biocompatibility of acoustic methods with regard to cells-in-droplets is well documented.

An acoustofluidic system according to the invention comprises a substrate having an essentially rectangular recess wherein the recess provides a microfluidic channel. Said microfluidic channel contains a fluid with droplets. At least one electromechanical transducer is attached tothe substrate adapted to excite an acoustic field in said channel. The side walls can be hard acoustic walls having a high specific acoustic impedance mismatch to said fluid in the channel and the transducer is configured to excite bulk acoustic waves (BAW) as standing waves of a predetermined harmonic resonance mode between said side walls. The acoustic waves couple into the fluid in the channel exerting acoustic pressure on droplets suspended in said fluid towards the pressure nodal line of the standing wave or towards the pressure antinode line, depending on the fluid and droplet properties.

The electromechanical transducers for droplet handling are preferably bulk piezoelectric transducers. The recess of the acoustofluidic system providing the channel in the substrate is covered by a glass plate closing the open surface. Thus, the channel is confined between the bottom in the substrate and the opposite glass plate, two side walls providing the reflective surfaces for the acoustic waves and an inlet wall and an outlet wall, which further define the system in different embodiments. The height of said channel compared to its width is chosen to be between 1:3 and 1:10, preferably between 1:4 and 1:6. The length is usually 5 to 20 times longer than the width, especially between 7 and 15 times.

On the inlet wall are provided two or more inlet nozzles adapted to deliver a fluid and/or a fluid comprising droplets. The inlet nozzle comprises a droplet generating T-junction adapted to deliver in conjunction with the fluid provided with a predetermined flow rate a droplet generating amount of a further liquid generating at the end wall of the channel a droplet having a diameter essentially similar to the height of the channel.

Then it is preferable, when the acoustofluidic system is employed for acoustophoretic droplet merging/fusion of droplets, that the flow rate of the fluid delivered by the inlet nozzles for two droplets to be combined, is a predetermined different rate, so that each slower droplet is recovered by one of the faster droplets creating a merged droplet on the center nodal line, wherein preferably the fluid rate and size of the slower and faster droplets is predetermined that the merged droplet is able to move on far away from the merging point in the channel before the next merger takes place.

Another application is droplet sorting; there the outlet end area of the channel outlet comprises two outlets with an intermediate separating wall, especially a rounded nose. Then, the separating wall is provided outside the middle axis of the channel, dividing the cross-section into a smaller outlet on the side of the intermediate separating wall and a broader outlet on the other side, so that when droplets are introduced into the channel on the side where the separating wall is provided, the droplet is steered in the smaller outlet when the transducer is not excited or when the transducer is excited in a λ mode, and that the droplet is steered to the broader outlet when the transducer is excited in a λ/2 mode, since the acoustic pressure pushes the droplet towards the central nodal line. λ denotes the acoustic wavelength in the system.

The acoustofluidic system can also be used for the exchange of the continuous fluid in which the droplets are suspended, wherein at least two inlet nozzles provide different first and second fluids and wherein any droplet provided in the first fluid is pushed out of this first fluid into the stream of the second fluid through the standing waves having a nodal centerline in the second fluid.

Droplets generated to enter into the channel usually have a diameter of 10-250 μm, especially when the height of the channel is in the range between 100 and 200 μm.

Further embodiments of the invention are laid down in the dependent claims.

### BRIEF DESCRIPTION OF THE DRAWINGS

Preferred embodiments of the invention are described in the following with reference to the drawings, which are for the purpose of illustrating the present preferred embodiments of the invention and not for the purpose of limiting the same. In the drawings,

FIG. 1A shows a sketch of a setup of a system for droplet handling with a bulk acoustic wave device according to an embodiment of the invention,

FIG. 1B shows the microfluidic chip from FIG. 1A in detail, handling system with a bulk acoustic wave device,

FIG. 3 shows the function of droplet sorting within an embodiment of a droplet handling system with a bulk acoustic wave device,

FIG. 4 shows a detail of the device for droplet sorting of FIG. 3,

FIG. 5 shows a detail of the device for droplet sorting of FIG. 3 with two different acoustic wave modes, and

FIG. 6 shows the function of exchange of continuous phase of dispersed droplets.

### DESCRIPTION OF PREFERRED EMBODIMENTS

The acoustofluidic system according to the invention, where an acoustic field is set up by a transducer in a microfluidic channel containing a carrier fluid and suspended droplets, is described in the following.

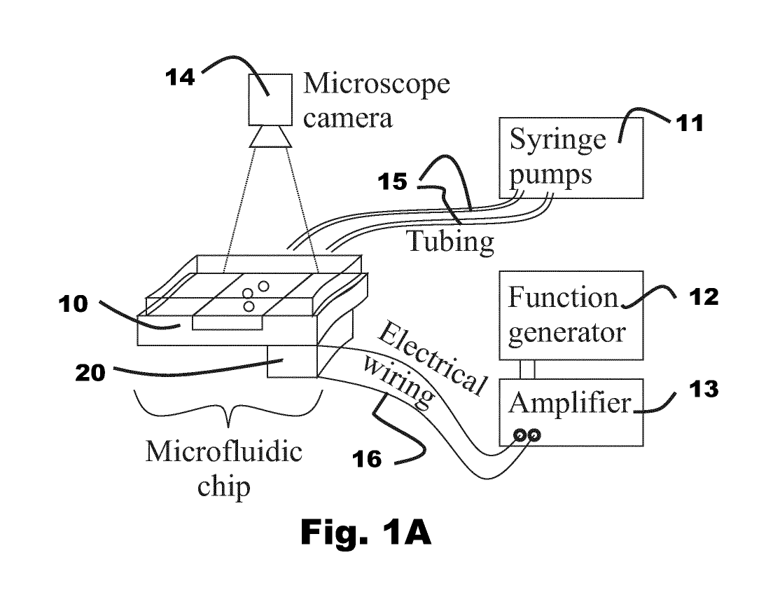

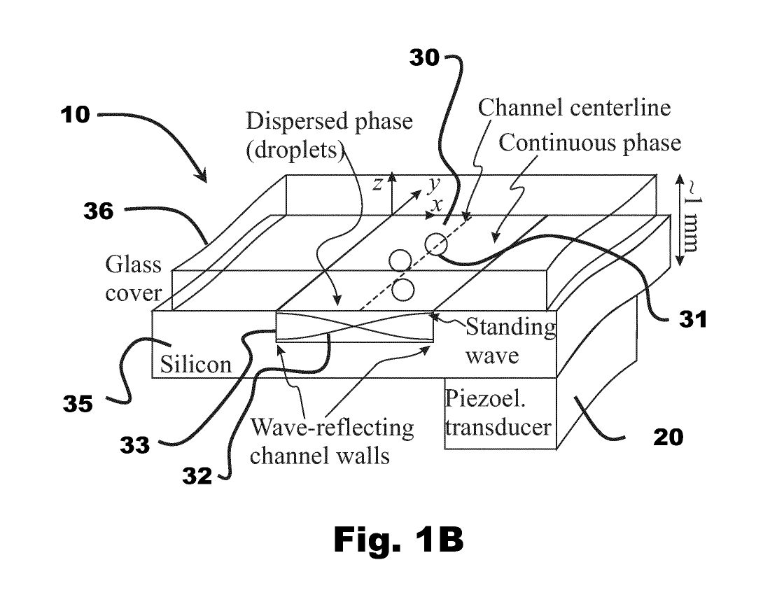

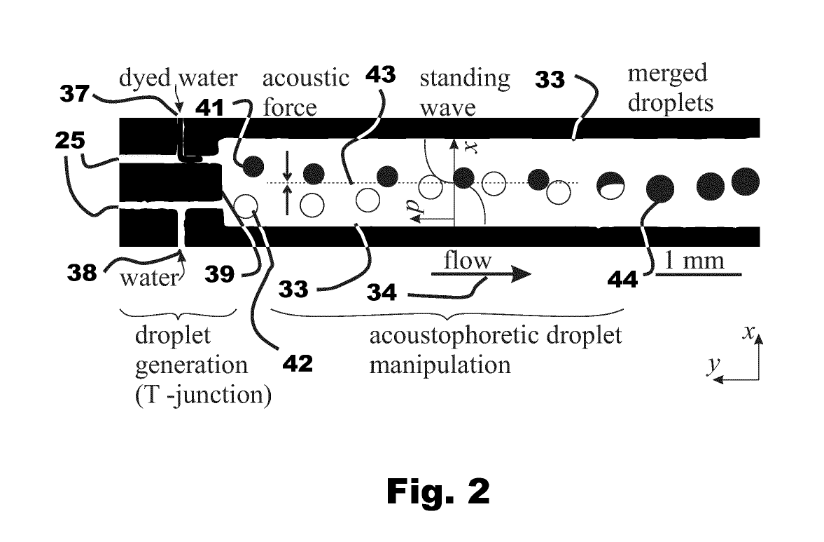

FIG. 1A shows a sketch of a setup of a system for droplet handling with a bulk acoustic wave device and FIG. 1B shows the microfluidic chip from FIG. 1A in detail.

As illustrated in FIG. 1A, the setup consists of a microfluidic chip 10 for both droplet generation and subsequent acoustophoretic manipulations, and optical/electrical/fluidic peripheral devices connected to the chip 10. Such additional peripheral devices can be inter alia syringe pumps 11, a function generator 12 connected to an amplifier 13 and a microscope camera 14. The pumps 11 are providing fluids, especially at least two different fluids, via tubing 15 to the chip 10. One fluid can be a (transparent) oil as basis fluid in the embodiments of FIGS. 2, 3, 4, 5 and band the other fluids are the substance to generate the droplets to be generated. The function generator 12 generates the electrical signals transmitted via electrical wiring 16 to the piezoelectric transducer 20.

On the chip 10, as shown in the detail view of FIG. 1B, microfluidic channels 30 of typically 1 mm width (in x-direction) and >8 mm length (in y-direction) were dry-etched ˜200 μm (micrometer) deep (in z-direction) in a silicon wafer 35 (thickness 425 μm), which was covered with a glass wafer 36 (500 μm) by anodic bonding. The wafer was diced into devices of typically x times y=8 mm×24 mm size.

Syringe pumps 11 (filled with the continuous and the dispersed phase) were connected to the channel inlets by tubings 15. These pumps 11 generate a flow, which can generate droplets 31, when the flows of the immiscible continuous and dispersed phase come together in a T-junction or a flow focusing geometry, as described in literature, e.g. by Christopher, G. F. and Anna, S. L., in “Microfluidic methods for generating continuous droplet streams”, Journal of Physics D:Applied Physics, 40, 19, 319-336, 2007.

Reference numeral 32 designates the standing pressure waves shown in FIG. 1B as a X shaped λ/2 mode waveform reflected between opposing wave-reflecting channel walls 33 in the chip substrate material of chip 35. The piezoelectric transducer is mounted on the right side of the substrate 35 opposite to the glass cover 36.

To generate an ultrasonic field within the fluidic domain, the piezoelectric transducer 20 transforms an electric sinusoidal voltage into mechanical vibration at a tunable frequency f. This BAW excitation method is known from particle acoustophoresis and is often called “transversal resonator”. The piezoelectric substrate excites a vibration in the silicon and thereby also in the oil. Bounded by the mismatch of the characteristic acoustic impedance Z=ρc (density times speed of sound) of oil and silicon at the fluid/structure interface (modeled as a hard wall condition), certain fluid resonance modes across the channel width w are feasible, when n·λ/2=w fits between left and right channel wall with n=1, 2, 3 . . . for the first, second and third harmonic and the acoustic wavelength λ. The resonance frequencies f=c·n/(2w) with the speed of sound c in the continuous phase result. If the transducer is tuned to such a resonance frequency, this leads to the formation of an ultrasonic standing wave in the fluid. As an example, the resonance mode with λ/2 across the channel is shown with reference numeral 32 in FIG. 1B. Since the channel height is far smaller than λ/2, no disturbing resonances in z-direction are expected.

FIG. 2 shows the function of droplet merging within an embodiment of a droplet handling system with a bulk acoustic wave device. Tubing 15 are connected to two parallel oil conducts 25 oriented in parallel to the longitudinal direction of the microfluidic channel. The channel is delimited by the wave-reflecting channel walls 33. Arrow 34 shows the flow direction. Within the substrate 35 are also provided two T-junctions between the oil conducts 25 and the conduct 37 for dyed water and the opposite conduct 38 for water.

The dyed droplets 41 (upper half) and the light droplets 42 (lower half) are moved together by the acoustophoretic force which moves all droplets towards the horizontal channel centerline 43. One fluid-oil suspension is delivered at a higher rate to ensure that the slower droplet is reached by the faster travelling droplet. In the embodiment shown, the undyed water from the lower T-junction is travelling slower. Since both chains of droplets 41, 42 move together to the centerline 43, each slower droplet 42 is reached by a faster droplet 41 to generate the merged droplet 44.

The fluiddynamic system has a small Reynolds number Re<<1, small Weber number We<<1 and small Bond number Bo<<1, which means that surface tension and viscous forces advantageously dominate over inertial and gravity effects. This leads to dimensionally stable discrete droplets and controllable laminar flows. The dominating surface tension and viscous forces are related in the capillary number. In the shown system, the capillary number was suitable for droplet generation in the dripping as well as the squeezing regime.

Droplets will experience a drag force (Stokes' drag) by the Poiseuille-flow in the rectangular channel 30. Once the resonance frequency of the electromechanical transducer is matched to the desired fluid resonance frequency, the power consumption of the devices can be lowered even further.

All but the simplest fluidic laboratory procedures require two fluids to be mixed. Hence in droplet microfluidics, fusion of two droplets enables reaction initiation, reagent dosing, dilution and incubation of cells in droplets. It is the microfluidic analog to pipetting two samples together in a macroscale test tube.

In FIG. 2, the on-demand one-to-one merging of two droplets in continuous flow is induced by focusing them on the channel centerline 43 (corresponding to a pressure nodal line) with BAW acoustophoresis. A resonance mode with a standing pressure wave of λ/2=w across the channel width w=1 mm was tuned. The resonance frequency of f=464 kHz was found to perform best in the experiment. A simple 1D calculation gives f=c/λ=(1004 m/s)/(2 mm)=502 kHz, which is 8% higher than in the experiment. Such differences are usually found, since the complex 3D fluid-structure coupled acoustic problem with compliant silicon boundaries is only vaguely approximated by the 1D calculation with hard wall boundaries.

As shown in FIG. 2 the dyed and undyed droplet 41 and 42 enter into the main channel, driven by an oil flow (15 μl/min in total). The dyed droplet 41 is faster, denoting a higher oil flow rate in the upper T-junction 25. Therefore and because the flow rate was smaller for the dyed water (0.2 μl/min) than for the undyed water (0.5 μl/min), the dyed and undyed droplet have a different size. The diameter of the undyed droplet was larger than the channel height h=190 μm, whereas the dyed droplets were smaller than the channel height. Therefore, the undyed droplets were squeezed in z-direction to a disk-like shape, whereas the dyed droplets remain spherical. The droplet contact with the channel top and bottom slowed the undyed droplets down. The faster dyed droplet was therefore found to catch up with the larger droplet, resulting in a synchronized fusion of droplet pairs. The merged droplet is even slower due to friction at the channel top and bottom.

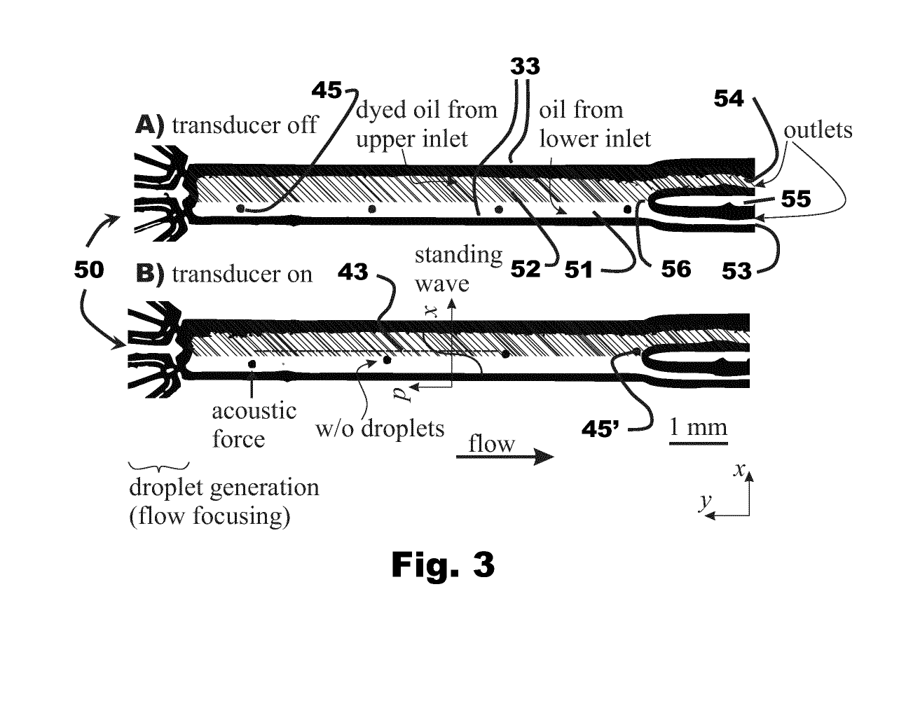

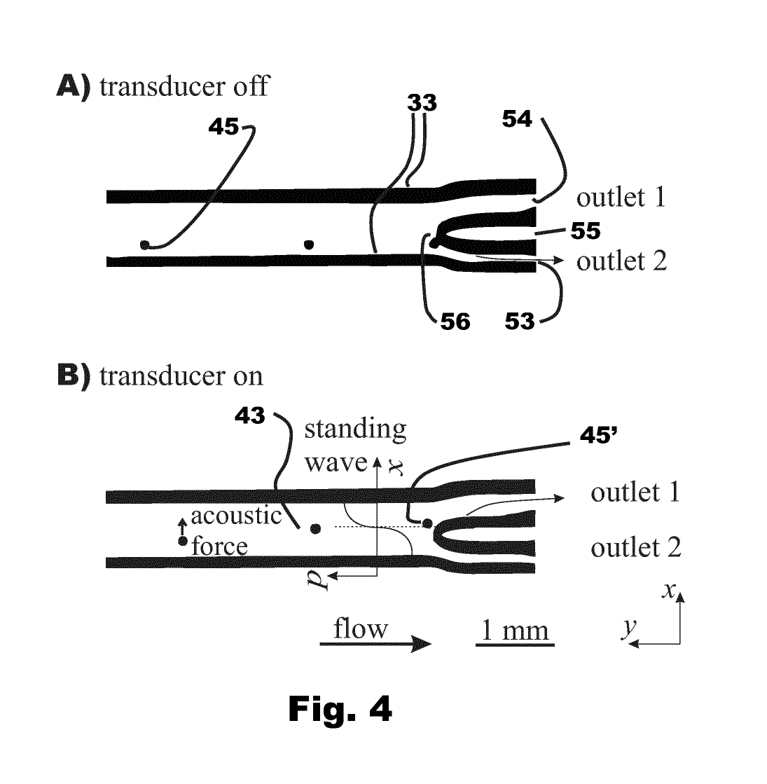

FIG. 3 shows the function of droplet sorting within an embodiment of a droplet handling system with a bulk acoustic wave device, and FIG. 4 shows a detail of the device for droplet sorting of FIG. 3. Same reference numerals and wordings are chosen for similar features. FIG. 3A shows the device, when the transducer 20 is turned off and FIG. 3B shows the device, when the transducer 20 is turned on.

On the left side of FIG. 3A and 3B inlet elements 50 for droplet generation are provided. Droplets are only generated by the lower T-junction device providing the light fluid area 51 with oil from the lower inlet. The upper T-junction provides the dyed oil or darker oil area 52 with dyed oil from the upper inlet.

In FIG. 3A the droplets are not moving perpendicular to the longitudinal flow direction of the channel 30 between the wave reflecting walls 33. At the end of the channel 30, opposite to the droplet generation area, a bifurcation is provided for the fluid channel 30. There is an upper outlet 54 and a lower outlet 53. The two outlets 53 and 54 are provided in the view from above of FIG. 3 over the hole depth of the channel 30. The channels 53 and 54 are separated by an intermediate wall 55, which is provided more towards the right sided wall 33 (in view of the flow direction) of the channel 30. This results in a narrower lower outlet 53 and a wider upper outlet 54. It is noted that the word upper and lower are used in connection with the drawing since FIG. 3 shows a view from above, i.e. an image as seen by the camera 14 of FIG. 1A.

In FIG. 3A no standing wave is generated by the function generator 12. Thus, the droplets 45 provided by the lower inlet 50 remain in the light oil area 51 and are bifurcated into the narrower, lower outlet 53. Most of the dyed oil is flowing within the upper wider outlet 54, as well as a part of the lighter oil, under the assumption that a similar fluid flow is provided for light and dyed oil.

FIG. 3B now shows the situation with the standing wave 32 applied. This tends to push the droplets with the applied acoustic force towards the horizontal centerline 43, which they reach as shown in FIG. 3B after approximately ⅔ of the channel length. Then the nose 56 separating the two channels ensures that the droplet 45 is diverted into the upper outlet 54. This is due to the fact that the nose 56 is provided “lower” (in the drawing of FIG. 3B, but in technical terms more to the right when seen in the longitudinal direction of flow) in view of the centerline 43. The rounded nose 56 is provided within the light oil half area 51. Thus a droplet 45′ being on the centerline is diverted to the larger upper outlet, by the way together with a part of the light fluid; in other words: droplets 45 enter the device with the light fluid and leave the device in the dyed fluid.

FIG. 4 shows a detail of the device for droplet sorting of FIG. 3. Droplets 45 leave through the upper outlet when the droplet 45′ paths are deflected acoustophoretically.

To enable droplet-based screenings, a sorting mechanism for droplets is required. The combination of droplet sensor (e.g. fluorescence detector) with a sorting mechanism as shown in connection with FIGS. 3, 4 and 5 allows for fluorescence-activated droplet sorting (FADS), in analogy to the indispensable FACS technology for cells.

Different from the present invention, droplet sorting in different outlets has been demonstrated with standing SAW acoustic radiation forces, which act directly on the dispersed droplets rather than by drag forces as the acoustic streaming.

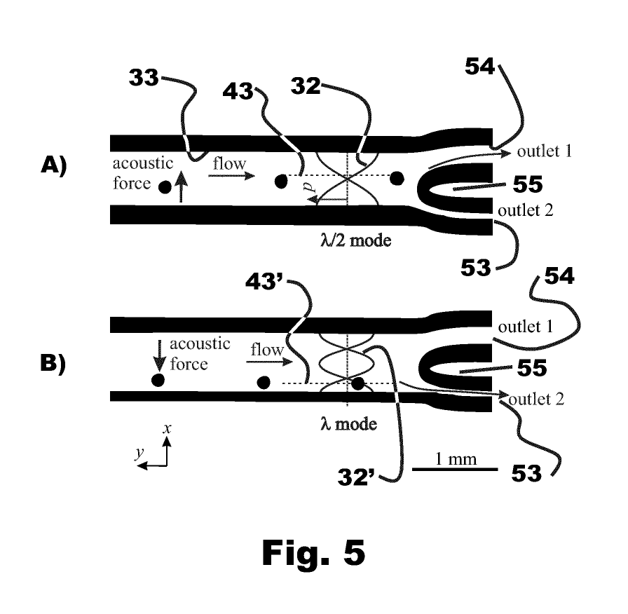

FIG. 5 shows a detail of the device for droplet sorting of FIG. 3 with two different acoustic wave modes. BAW acoustophoresis allows to sort droplets at channel bifurcations as demonstrated in FIG. 3. Here, switching the acoustophoretic transducer frequency allows to switch between the λ/2 and the λ mode at 463 kHz and 979 kHz, whereby the nodal lines 43 and 43′ of these fields direct the droplets to an upper/lower outlet, as shown in FIG. 5A and 5B. Excitation in FIG. 5A at 463 kHz generates a λ/2 mode, which deflects droplets in the upper outlet 54. Excitation in FIG. 5B at 979 kHz generates a λ mode, which deflects droplets in the lower outlet 53.

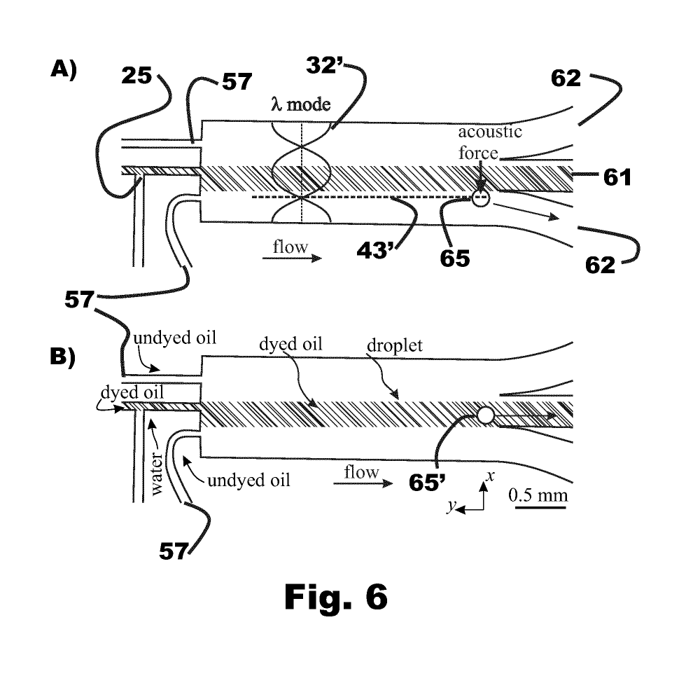

FIG. 6 finally shows the function of exchange of continuous phase of dispersed droplets with a λ mode at 970 kHz. One T-junction 25 is provided in the center of the inlet path of the channel 30 allowing input of dispersed droplets. Two oil inlets 57 are provided on both sides of the T-junction. That enables, in a cross-section a flow sequence from upper to lower (equivalent to left to right in FIG. 1) light continuous phase one, dyed continuous phase and light continuous phase two. On the outlet side, there are a central dyed oil outlet 61 and two side outlets 62 evacuating the light continuous phase one and two.

Dispersed droplets 65, 65′ are carried and separated from each other by the continuous phase liquid, here oil. Similar to particle acoustophoresis, the transfer of droplets to another continuous phase is employed for droplet washing and continuous flow concentration, e.g. to expose them to another surfactant in the continuous phase. This method enables e.g. to stabilize droplets by moving them from a surfactant-free continuous phase to a surfactant-carrying continuous liquid.

In FIG. 6, droplets 65′ experience an exchange of their suspending continuous phase from the dyed oil (center) to the undyed oil in the lower third of the channel 30. This is feasible because the acoustic radiation force acts selectively on the dispersed water droplet due to its spherical shape and its acoustic contrast to the surrounding oil, which is not affected by the ultrasound.

In the examples, water-in-oil droplets (silicone oil, Dow Corning® 200) were generated. Depending on the device and application, 0.1% stabilizing surfactant Span® 80 was added to the oil. Droplet diameters ranged from about 50 μm to 250 μm, especially between 100 and 250 μm.

For acoustophoresis, a transducer 20 for the excitation of harmonic bulk acoustic waves is required. A piezoelectric element Pz26 (Ferroperm) of typically 8 mm×1 mm×1 mm size was glued on the device. The piezoelectric element was excited by electrical wiring 16 to an amplifier 13, which amplifies the harmonic electrical excitation from a function generator 12 at resonance frequency (around 0.5 MHz) to an amplitude of ˜35 Vᵣₘₛ. This transducer 20 enables acoustophoresis: When the transducer 20 excites a vibration at the frequency of the first eigenmode, an ultrasonic standing wave 32 is excited in x-direction along the channel 30. The first eigenmode corresponds to the acoustic resonance mode where half a wavelength λ/2 of the wave corresponds to the width (in x-direction) of the channel, and the second eigenmode corresponds to the acoustic resonance mode where one wavelength λ of the wave corresponds to the width (in x-direction) of the channel. Droplets 45 in the channel will then be attracted to the pressure nodal lines or the pressure antinodes of the standing wave, depending on the material parameters of the continuous phase and the dispersed phase.

The operation of the invented device is described as follows: In FIG. 2, the merging of two droplets is induced by focusing them on the channel centerline 43 by the acoustophoretic force. This force originates from a λ/2 resonance mode. The droplets are attracted to the channel centerline because it corresponds to the pressure nodal line of the standing wave.

In FIG. 3, droplets experience a change of their continuous oil phase from the flow in the lower half (light) to the flow in the upper half (dyed) of the channel. This is feasible because the acoustic radiation force acts selectively on the dispersed water due to its spherical shape and its material parameters which lead again to an attraction of the droplets to the channel centerline 43.

In FIG. 4, the path of a droplet 45, 45′ can be deflected for switching between upper and lower outlet 53 and 54 depending on the excitation frequency. This is relevant for droplet sorting tasks. For example, a detection system might analyze the droplets upstream of the shown junction, and depending on the analyzed droplet characteristics, either “outlet 1” or “outlet 2” might be chosen as the path for the droplets.

Alternatives to the described system are surface acoustic wave (SAW) based devices as shown by Lee, C., Lee, J., Kim, H. H., Teh, S., Lee, A., Chung, I., Park, J. Y. and Shung, K. K., in “Microfluidic droplet sorting with a high frequency ultrasound beam”, in Lab on a Chip, 12, 15, 2736-2742, 2012; by Franke, T. and Abate, A. R. and Weitz, D. A. and Wixforth, A., Surface acoustic wave (SAW) directed droplet flow in microfluidics for PDMS devices, Lab on a Chip, 9, 18, 2625-2627, 2009 and finally by Li, S. and Ding, X. and Guo, F. and Chen, Y. and Lapsley, M. I. and Lin, S. S. and Wang, L. and McCoy, J. P. and Cameron, C. E. and Huang, T. J., in “An On-Chip, Multichannel Droplet Sorter Using Standing Surface Acoustic Waves”, Analytical Chemistry, 85, 11, 5468-5474, 2013.

The invention at hand is distinguished from these devices by the difference between the BAW and the SAW technique. Acoustofluidic systems for the handling of particles (rather than droplets) have recently been described in a Tutorial Series in the scientific journal Lab on a Chip (Acoustofluidics 1-23, Lab on Chip, 2011 to 2013), starting with reference from Bruus, H. and Dual, J. and Hawkes, J. J. and Hill, M. and Laurell, T. and Nilsson, J. and Radel, S. and Sadhal, S. and Wiklund, M., as “Forthcoming Lab on a Chip tutorial series on acoustofluidics: Acoustofluidics—exploiting ultrasonic standing wave forces and acoustic streaming in microfluidic systems for cell and particle manipulation”, in Lab on a Chip, 11, 21, 3579-3580, 2011, and ending with an article written by Glynne-Jones, P. and Hill, M., “Acoustofluidics 23: acoustic manipulation combined with other force fields”, in Lab on a Chip, 13, 6, 1003-1010, 2013. This series includes details of the building of acoustofluidic devices as by Lenshof, A. and Evander, M. and Laurell, T. and Nilsson, J., in “Acoustofluidics 5: Building microfluidic acoustic resonators”, Lab on a Chip, 12, 4, 684-695, 2012 and the underlying physics is explained by Bruus, H., Acoustofluidics 7: in “The acoustic radiation force on small particles”, in Lab on a Chip, 12, 6, 1014-1021, 2012. Whereas the device type is similar, the invention described here is meant specifically for the handling of droplets.

The aim of the invention is an acoustofluidic system, consisting of a microfluidic channel which contains a fluid (continuous phase) with droplets (dispersed phase), and an acoustic field excited in said channel by means of electromechanical transducers which excite bulk acoustic waves (BAW), which couple into the fluid for the mechanical handling and movement of the suspended droplets. Preferably, the transducers for droplet handling are bulk piezoelectric transducers. Preferably, the ultrasonic standing wave is generated between two wave-reflecting channel walls with a high specific acoustic impedance mismatch to the water. Furthermore, the operating frequency corresponds to a certain harmonic resonance mode within the fluidic domain and eventually the surrounding structure. The ultrasonic standing waves are used for droplet handling. The acoustofluidic system is employed for acoustophoretic droplet handling tasks such as droplet sorting. The acoustofluidic system can also be used for acoustophoretic droplet handling tasks such as droplet merging/fusion or droplet storing. Such an acoustofluidic system can be employed for acoustophoretic droplet handling tasks such the exchange of the continuous fluid in which the droplets are suspended. Usually, droplets of the diameter of 10-250 μm are handled.

LIST OF REFERENCE SIGNS

| | |
|---|---|
| 10 | chip |
| 11 | pumps |
| 12 | function generator |
| 13 | amplifier |
| 14 | camera |
| 15 | tubing |
| 16 | wiring |
| 20 | piezoelectric transducer |
| 25 | oil conduct |
| 30 | channel |
| 31 | droplet |
| 32 | standing wave (λ/2) |
| 32′ | standing wave (λ) |
| 33 | wave reflecting channel walls |
| 34 | flow direction |
| 35 | substrate |
| 36 | glass plate |
| 37 | dyed water T-junction |
| 38 | clear water T-junction |
| 39 | end wall |
| 41 | dyed droplet |
| 42 | light droplet |
| 43 | centerline (λ/2 mode) |
| 43′ | nodal line (λmode) |
| 44 | merged droplet |
| 45 | droplet (not diverted) |
| 45′ | droplet (diverted) |
| 50 | inlet elements |
| 51 | light oil area |
| 52 | dyed oil area |
| 53 | lower smaller outlet |
| 54 | upper broader outlet |
| 55 | intermediate wall |
| 56 | nose |
| 57 | oil inlet |
| 61 | central outlet |
| 62 | side outlet |
| 65 | droplet (phase exchange) |
| 65′ | droplet remain in phase |

1.-13. (canceled)

14. An acoustofluidic system, comprising
a substrate;
at least one electromechanical transducer attached at the substrate;
an essentially rectangular recess within the substrate;
a fluid provided within the rectangular recess;
at least a droplet provided within the fluid;
wherein the rectangular recess comprises two opposite side walls, wherein the recess provides a microfluidic channel containing the fluid with said droplets, wherein the at least one electromechanical transducer is configured to excite an acoustic field in said microfluidic channel, wherein the transducer is configured to excite bulk acoustic waves as standing waves of a predetermined harmonic resonance mode between said side walls, which couple into the fluid in the channel exerting acoustic radiation forces on said droplets suspended in said fluid towards the pressure nodal line of the standing wave or towards the pressure antinode line of the standing wave, depending on the fluid and droplet properties.

15. The acoustofluidic system according to claim 14, wherein the side walls of the channel are acoustically hard walls having a high specific acoustic impedance mismatch to said fluid in the channel.

16. The acoustofluidic system according to claim 14, wherein the electromechanical transducers for droplet handling are bulk piezoelectric transducers.

17. The acoustofluidic system according to claim 14, wherein the microfluidic channel in the substrate is covered by a glass plate.

18. The acoustofluidic system according to claim 14, wherein the height of the channel compared to its width is between 1:3 and 1:10.

19. The acoustofluidic system according to claim 18, wherein the height of the channel compared to its width is between 1:4 and 1:6.

20. The acoustofluidic system according to claim 14, further comprising two or more inlet nozzles adapted to deliver a fluid and/or a fluid comprising droplets.

21. The acoustofluidic system according to claim 19, wherein the inlet nozzle comprises a droplet generating T-junction adapted to deliver in conjunction with the fluid provided with a predetermined flow rate a droplet generating amount of a further liquid generating at the end wall of the channel a droplet having a diameter essentially similar to the height of the channel.

22. The acoustofluidic system according to claim 19, employed for acoustophoretic droplet merging/fusion, wherein the flow rate of the fluid delivered by the inlet nozzles is a predetermined different rate, so that each slower droplet is recovered by one of the faster droplets creating a merged droplet on the center nodal line.

23. The acoustofluidic system according to claim 22, wherein the fluid rate and size of the slower and faster droplets is predetermined so that the merged droplet is able to move on far away from the merging point in the channel before the next merger takes place.

24. The acoustofluidic system according to claim 14, employed for acoustophoretic droplet handling tasks such as droplet sorting, wherein the end area of the channel outlet comprises two outlets with an intermediate separating wall.

25. The acoustofluidic system according to claim 24, wherein the intermediate separating wall is a rounded nose.

26. The acoustofluidic system according to claim 24, wherein the separating wall is provided outside the middle axis of the channel, dividing the cross-section into a smaller outlet on the side of the intermediate separating wall and a broader outlet on the other side, so that when droplets are introduced into the channel on the side where the separating wall is provided, the droplet is evacuated in the smaller outlet when the transducer is not excited or when the transducer is excited in a λmode, and that the droplet is evacuated in the broader outlet when the transducer is excited in a λ/2 mode, since the acoustic pressure pushes the droplet towards the central nodal line.

27. The acoustofluidic system according to claim 14, employed for the exchange of the continuous fluid in which the droplets are suspended, wherein at least two inlet nozzles provide different first and second fluids and wherein any droplet provided in the first fluid is pushed out of this first fluid into the stream of the second fluid through the standing waves having a nodal centerline in the second fluid.

28. The acoustofluidic system according to claim 14, wherein the droplets are generated to be entered into the microfluidic channel having a diameter of 10-250 μm.

29. The acoustofluidic system according to claim 28, wherein the height of the channel is in the range between 100 and 200 μm.

30. The acoustofluidic system according to claim 14, wherein at least one of said droplets contains at least one cell or at least one virus.
